(19) United States
(12) Patent Application Publication
(10) Pub. No.: US 2026/0203639 A1
(43) Pub. Date: Jul. 16, 2026

(54) METHOD FOR CONFIGURING AND CONTROLLING AN ELECTRICAL CONVERTER, CONVERTER CONTROLLER, AND CONVERTER

(71) Applicant: Siemens Aktiengesellschaft, München (DE)

(72) Inventors: Daniel Hein, München (DE); Steffen Limmer, München (DE); Volkmar Sterzing, Neubiberg (DE); Gopal Mondal, Erlangen (DE); Sebastian Nielebock, Forchheim (DE)

(21) Appl. No.: 18/704,592

(22) PCT Filed: Oct. 24, 2022
(86) PCT No.: PCT/EP2022/079652

§ 371 Date: Mar. 10, 2026

(30) Foreign Application Priority Data
Oct. 29, 2021 (EP) 21205490.2

(51) Int. Cl. G06N 20/00

(52) U.S. Cl. CPC G06N 20/00

(57) ABSTRACT

In order to configure the converter (CON), a plurality of operating data sets (BD) of the converter is read in, the converter comprising: —an adjustable reference generator (RGEN) for generating a reference signal (RF) for an output signal (VABC) of the converter; —a pulse width modulator (PWM) for producing a square-wave signal (RS) which is pulse-width-modulated by means of the reference signal (RF); and —a transforming unit (TP) for transforming the square-wave signal (RS) into the output signal (VABC). The operating data sets (BD) are each fed into a first machine learning module (ML1). According to the invention, for each resulting output data set (SD1) of the first machine learning module a converter performance resulting from an adjustment of the reference generator (RGEN) on the basis of said output data set (SD1) is determined. The first machine learning module (ML1) is then trained, by means of a numerical optimization method, to optimize the determined performance. In order to control the converter (CON), present operating data sets (BD) of the converter are continually acquired and fed into the trained first machine learning module (ML1). By means of the first adjustment data sets (SDI) outputted by the first machine learning module (ML1), the reference generator (RGEN) is continually adjusted.

Electrical converters, for example voltage converters, frequency converters, converters, inverters, power inverters or other electrical energy transducers, often produce their output voltage by means of a pulse-width-modulated square-wave signal. The pulse width modulation in this instance permits an rms output voltage or output power of the converter to be regulated. The square-wave signal ideally either fully connects or fully blocks an input voltage of the converter in short time intervals. Resistive energy losses essentially occur only during very short time intervals needed for changing between the two switching states. For this reason, it is usually desirable to change over between the switching states in as short a time as possible. However, a fast changeover generally promotes generation of electromagnetic interference.

The pulse-width-modulated square-wave signal can be filtered by a low pass filter in order to smooth the steep switching edges and generate a more or less smooth output signal. Alternatively, the square-wave signal can also be output directly, for example in order to supply power to an electric motor whose winding smooths the switching edges by itself.

The control of a converter in general and of pulse width modulation in particular is often defined by a set of adjustment parameters. Insofar as a converter may be subject to quite different operating conditions, e.g. in terms of output power, operating temperature, mains impedance, damping, offset currents or voltage dips, such adjustment parameters are often defined in a very conservative way. Such definitions are in many cases not optimum for all operating conditions, however.

It is the object of the present invention to specify a method for configuring and a method for controlling an electrical converter and also a converter controller and an electrical converter that have better performance, in particular given changing operating conditions.

This object is achieved by a method having the features of patent claim 1, by a method having the features of patent claim 4, by a converter controller having the features of patent claim 14, by an electrical converter having the features of patent claim 15, by a computer program product having the features of patent claim 16 and by a computer-readable storage medium having the features of patent claim 17.

Control of an electrical converter is accomplished by virtue of a reference signal for an output signal of the converter being generated by an adjustable reference generator. A pulse width modulator generates a square-wave signal pulse-width-modulated by the reference signal, said square-wave signal being converted into the output signal. Furthermore, operating datasets that specify operating conditions of the converter are continually acquired and fed into a first machine learning module. According to the invention, the first machine learning module is trained to take a respective operating dataset as a basis for outputting a respective first adjustment dataset for adjusting the reference generator, application of which optimizes a performance of the converter. Accordingly, the reference generator is continually adjusted by first adjustment datasets that are output by the first machine learning module.

Configuration of an electrical converter that has an adjustable reference generator for generating a reference signal for an output signal of the converter, a pulse width modulator for generating a square-wave signal pulse-width-modulated by the reference signal and a conversion unit for converting the square-wave signal into the output signal is accomplished by reading in a multiplicity of operating datasets that specify operating conditions of the converter. Each of the operating datasets is fed into a first machine learning module as an input dataset. According to the invention, for a particular resulting output dataset of the first machine learning module, a performance of the converter that results from an adjustment of the reference generator on the basis of this output dataset is ascertained in the form of one or more performance values. The first machine learning module is then trained by means of a numerical optimization method to optimize the ascertained performance values. The trained first machine learning module configures the converter.

To carry out a method according to the invention, there is provision for a converter controller, an electrical converter, a computer program product and a computer-readable, preferably nonvolatile, storage medium.

The methods according to the invention and also the converter controller according to the invention and the electrical converter according to the invention can be carried out, or implemented, by means of one or more processors, computers, application-specific integrated circuits (ASICs), digital signal processors (DSPs) and/or so-called field programmable gate arrays (FPGAs), for example.

An advantage of the invention can be seen in particular in that dynamic adjustment of a reference generator allows the reference signal to be continually matched to current operating conditions of the converter. Insofar as the reference signal generally has considerable influence on a performance of the converter, the performance can be significantly improved in many cases, in particular under changing operating conditions, compared with operation with a firmly predefined reference signal. In addition, the use of a data-driven machine learning module allows even complex causal relationships between adjustment parameters of the reference generator and the performance of the converter to be well represented.

Advantageous embodiments and developments of the invention are specified in the dependent claims.

According to one advantageous embodiment of the invention, control of the converter can be accomplished by virtue of the first machine learning module being trained to take a respective operating dataset as a basis for outputting a respective second adjustment dataset, which specifies a carrier frequency and/or a modulation depth, for adjusting the pulse width modulator, application of which optimizes a performance of the converter. Accordingly, the pulse width modulator can be continually adjusted by second adjustment datasets that are output by the first machine learning module. Such addition of further optimization parameters allows the performance to be improved further in many cases.

According to one advantageous development of the invention, control of the converter can be accomplished by virtue of the performance being specified by multiple performance measures, weighted on the basis of a weight value set, for different optimizable target variables of the converter. The first machine learning module may accordingly be trained to take a respective operating dataset and a respective weight value set as a basis for outputting a respective first adjustment dataset for adjusting the reference generator, application of which optimizes the performance of the converter weighted by the respective weight value set. A second machine learning module may be trained to take operating datasets of the converter as a basis for selecting one of the performance measures and/or for outputting a weight value set, which performance measure or weight value set, when fed into the trained first machine learning module, optimizes a performance of the converter. Accordingly, operating data of the converter can be fed into the second machine learning module, and output data of the second machine learning module can be fed into the first machine learning module. The reference generator can then be continually adjusted by first adjustment datasets that are output by the first machine learning module. The interaction of the first and second machine learning modules allows different performance targets to be dynamically prioritized depending on the prevailing operating situation. As such, the optimization can automatically be based on different or differently weighted performance measures in critical operating states than during normal operation.

According to another advantageous embodiment of the invention, configuration of the converter can be accomplished by ascertaining a respective performance value by adjusting a simulated reference generator of a simulation model of the converter, the reference generator of the converter and/or a reference generator of a similar converter on the basis of the respective output dataset, and taking this as a basis for ascertaining a performance that results during operation under the operating conditions specified by the respective operating dataset.

According to one advantageous development of the invention, configuration of the converter can be accomplished by virtue of the ascertainment of the performance involving multiple performance measures for different optimizable target variables of the converter being ascertained. Furthermore, a multiplicity of different weightings for the performance measures can be generated in the form of a respective weight value set. Training of the first machine learning module can then be accomplished by feeding the generated weight value sets together with the operating datasets into the first machine learning module as input datasets.

In particular, the trained first machine learning module can be used to train a second machine learning module to take operating datasets of the converter as a basis for selecting one of the performance measures and/or for outputting a weight value set, which performance measure or weight value set, when fed into the trained first machine learning module, optimizes a performance of the converter.

Furthermore, the numerical optimization method used for configuring the converter may comprise in particular a genetic optimization method, a particle swarm optimization, a symbolic regression method and/or a back-propagation method. There are a multiplicity of efficient numerical implementations available for numerical optimization methods such as these.

According to other advantageous embodiments of the invention, a performance may relate to an efficiency of the converter, a variance of the output signal from the reference signal, a harmonic content of the output signal, a stability of the output signal, a common-mode component of the output signal and/or electromagnetic interference coming from the converter. The invention permits quite different operating variables of the converter to be easily incorporated into the performance optimization.

In addition, depending on the adjustment of the reference generator, the reference signal can be selected from multiple provided reference signals, a response or a shape of the reference signal can be modified, a generation process for the reference signal can be modified, and/or operators for signal logic combination and/or signal conversion can be selected, which are taken as a basis for forming the reference signal from provided signals.

Further, a respective machine learning module may comprise an artificial neural network, a Bayesian neural network, a recurrent neural network, a convolutional neural network, a multilayer perceptron, an autoencoder, a deep learning architecture, a support vector machine, a data-driven trainable regression model, a k-nearest neighbor classifier, a physical model and/or a decision tree.

In particular, the first machine learning module used may be a stateful machine learning module, for example in the form of a recurrent neural network. This allows in particular temporal patterns or temporal dynamics to be detected in the operating data and taken into consideration for controlling the converter.

Furthermore, control of the converter can be accomplished by training the first machine learning module, or by virtue of the first machine learning module being trained, to take a respective operating dataset as a basis for outputting a respective third adjustment dataset, which specifies a changeover time of the square-wave signal, for adjusting the pulse width modulator, application of which optimizes a performance of the converter. Accordingly, the pulse width modulator can be continually adjusted by third adjustment datasets that are output by the first machine learning module. Such addition of further optimization parameters allows the performance to be improved further in many cases.

A respective changeover time can be specified in particular relative to a fundamental period of the output signal or in the form of a phase angle. Preferably, the ascertainment of the changeover times can involve symmetries of the fundamental period being utilized, for example a symmetry of the two half-cycles and/or of the quarter-cycles. As such, e.g. the changeover times in the second half-cycle can be chosen to be symmetrical with respect to the changeover times in the first half-cycle. Such a reduction in the ultimately optimizable changeover times allows an amount of training to be reduced in many cases.

An exemplary embodiment of the invention is explained in more detail below on the basis of the drawing, in which, in a schematic representation in each case:

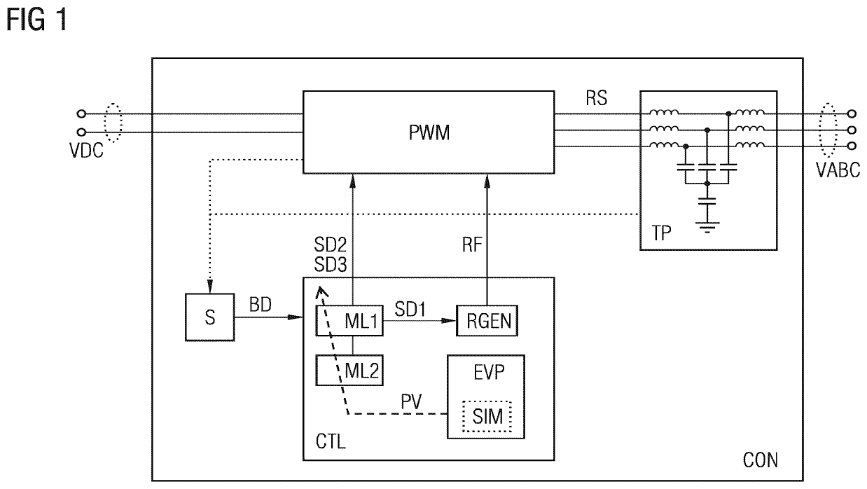

FIG. 1 illustrates an electrical converter having a converter controller according to the invention,

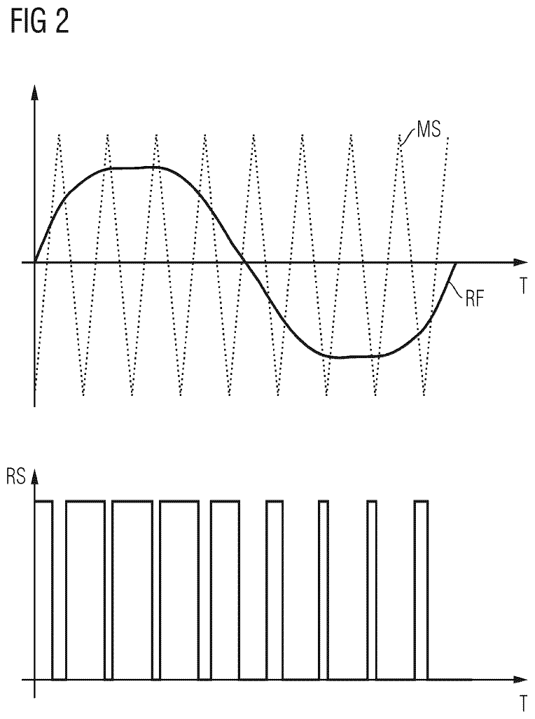

FIG. 2 illustrates a pulse width modulation of a square-wave signal by a reference signal,

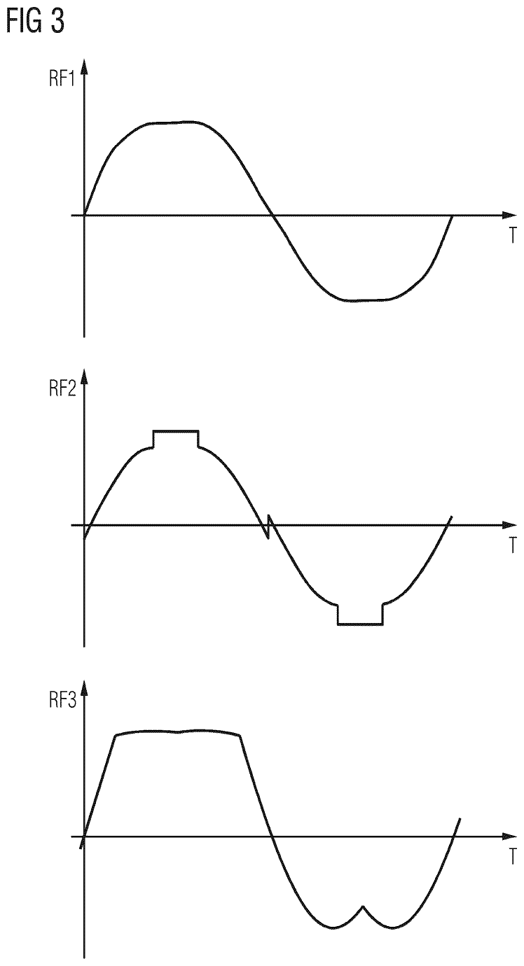

FIG. 3 illustrates various reference signals used as reference for an output signal of the converter, and

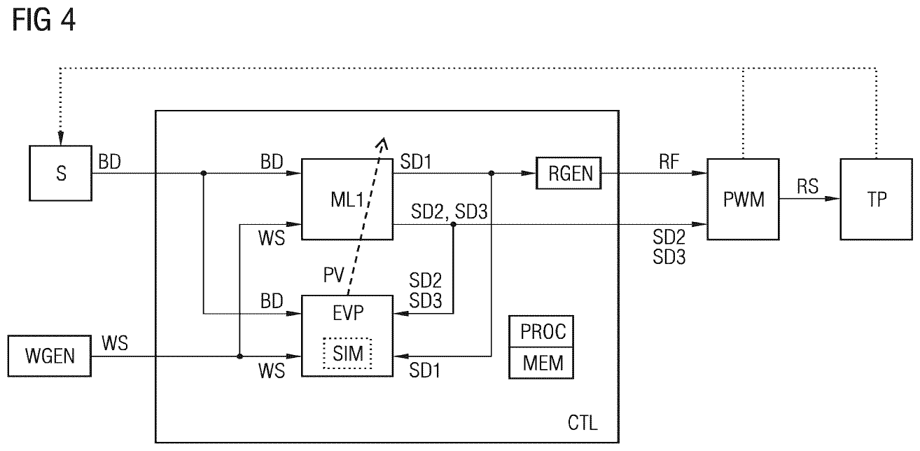

FIG. 4 illustrates a converter controller according to the invention during the training of a first machine learning module, and

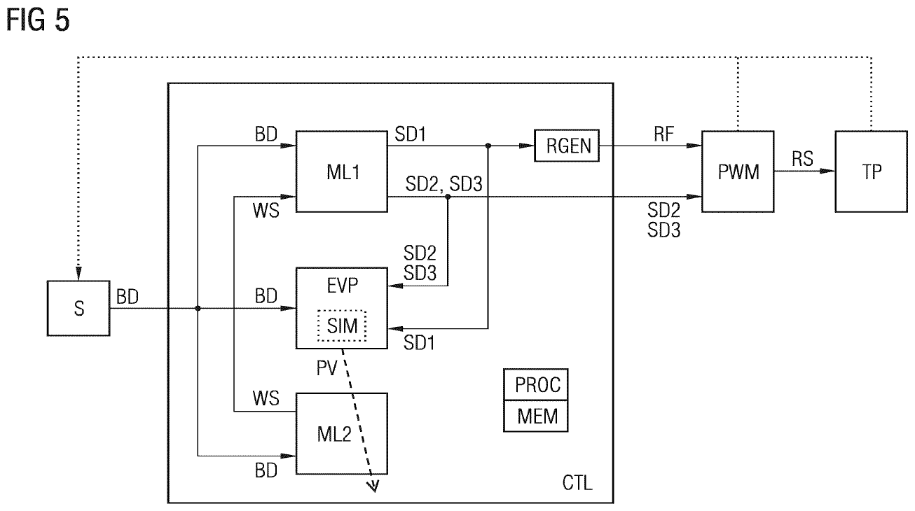

FIG. 5 shows a converter controller according to the invention during the training of a second machine learning module.

Insofar as identical or corresponding reference signs are used in the figures, these reference signs denote identical or corresponding entities that may be implemented or arranged in particular as described in connection with the relevant figure.

FIG. 1 uses a schematic representation to illustrate an electrical converter CON having a converter controller CTL according to the invention for controlling the converter CON. The electrical converter CON may be a voltage converter, a frequency converter, a converter, an inverter, a power inverter or another electrical energy transducer.

In the present exemplary embodiment, the converter CON is implemented as a power inverter that converts an input DC voltage VDC into a three-phase AC voltage. The three-phase AC voltage is output by the converter CON in the form of three output signals VABC. A three-phase AC voltage such as this is often referred to as three-phase AC for short. The output signals VABC may be provided to supply power to electrical devices or to feed into power grids.

The converter CON has a sensor system S that continually measures or otherwise acquires operating parameters of the converter CON. The measured or acquired operating parameters are transmitted from the sensor system S to the converter controller CTL in the form of operating datasets BD. The operating datasets BD specify operating states or operating conditions of the converter CON. In particular, the operating datasets BD can specify an input current, an input voltage, an output voltage, an output current, an output power, an operating temperature, a mains impedance, a damping, an offset current, a voltage dip, a current or voltage fluctuation or other operating or environmental parameters relevant to the operation of the converter CON or influencing the operation.

Operating datasets BD relevant to the operation of the converter CON may also originate from other sources apart from the sensor system S. By way of example, information about a power requirement that is to be expected can be received online via the Internet.

Furthermore, the converter CON has a pulse width modulator PWM to which the input DC voltage VDC is supplied. According to the known principles of pulse width modulation, the pulse width modulator PWM ideally either fully connects the input DC voltage VDC or blocks it completely, as a result of which a square-wave signal is generated. Insofar as a three-phase AC voltage is supposed to be output in the present exemplary embodiment, the pulse width modulator PWM generates three complementarily phase-shifted square-wave signals RS in this way. Each of the square-wave signals RS is pulse width modulated by a periodic reference signal RF.

The reference signals RF can be regarded as reference for the output signals VABC of the converter CON insofar as the pulse width modulation takes place such that a respective square-wave signal, after smoothing by a low pass filter, essentially follows a response of the associated reference signal RF. To produce the three-phase AC voltage VABC, the modulating reference signals RF are phase-shifted through 120 degrees with respect to one another as appropriate.

The pulse-width-modulated square-wave signals RS are fed by the pulse width modulator PWM into a low pass filter TP of the converter CON, which smooths the square-wave signals RS and outputs the smoothed signals as three-phase output signals VABC.

The reference signals RF are generated by a reference generator RGEN of the converter controller CTL and transmitted by the latter to the pulse width modulator PWM. For reasons of clarity, only one of these reference signals RF is considered by way of illustration below.

There are multiple well-known modulation methods available for performing a pulse width modulation on the basis of a reference signal, e.g. so-called space vector modulation.

A simple method for pulse width modulating a square-wave signal using a reference signal is illustrated in FIG. 2. The top part of FIG. 2 schematically represents a reference signal RF plotted against time T and a correspondingly plotted modulation signal MS. The modulation signal MS is a triangular-waveform signal and has a much higher frequency than the reference signal RF. The lower part of FIG. 2 likewise contains the pulse-width-modulated square-wave signal RS plotted against time T.

Pulse width modulation of the square-wave signal RS is accomplished by continually comparing the reference signal RF with the modulation signal MS using an electrical comparator. If a voltage of the reference signal RF is greater than a voltage of the modulation signal MS, the square-wave signal RS is connected, otherwise it is inhibited. This produces the pulse-width-modulated curve shape of the square-wave signal RS illustrated in the lower part of FIG. 2.

As also illustrated by FIG. 1, the pulse-width-modulated square-wave signal RS is supplied to the low pass filter TP and smoothed thereby. The smoothed output signal VABC then substantially follows the response of the modulating reference signal RF. Alternatively, the square-wave signal RS can also be output directly as the output signal of the converter CON, in order thus to supply power e.g. to an electric motor whose winding coils smooth the supply voltage by themselves.

The reference generator RGEN can generate a multiplicity of different reference signals RF. The way in which the reference signals RF are generated is adjustable within wide limits using adjustment parameters. To adjust the reference generator RGEN, the adjustment parameters are transmitted to the reference generator RGEN in the form of a first adjustment dataset SD1.

Depending on the transmitted first adjustment dataset SD1, the reference signal RF can be selected from multiple provided reference signals, a response or a shape of the reference signal can be modified, a generation process for the reference signal can be modified and/or operators for signal logic combination or signal conversion can be selected that are taken as a basis for forming the reference signal RF from provided signals.

The latter adjustment variant can involve for example a mathematical expression being specified using mathematical operators such as “+”, “−”, “*”, “/”, etc., using mathematical functions such as sine, cosine, min, max, abs, etc., using comparison operators such as “>”, “<”, “=”, etc. and/or using Boolean operators such as “and”, “or”, “not”, “if”, “else”, etc.

In this way, e.g. a sinusoidal signal IN1 and a constant signal IN2 can be logically combined to produce a reference signal RF according to RF=IN1−(IN1−IN2)*heaviside(IN1−IN2) or according to RF=heaviside(IN1−IN2). The heaviside function is known to have the value 1 for positive arguments and the value 0 for negative arguments.

Signal logic combinations such as these can be used to adjust a shape of the signal generation that is easily interpretable by experts. The closed shape of such expressions for signal generation allows much higher cycle frequencies of the converter controller CTL. This in turn promotes the use of such converter controllers in silicon-carbide-based converters. The latter permit much higher switching frequencies and therefore generally require less complex low pass filters and/or have higher efficiency.

FIG. 3 illustrates various types of reference signals RF that can be generated by the reference generator RGEN on the basis of the first adjustment dataset SD1. The upper and lower parts of FIG. 3 each contain a continuous reference signal RF1 and RF3, respectively, plotted against time T, while the middle part of FIG. 3 shows a discontinuous reference signal RF2.

Pulse width modulation using a continuous reference signal often leads firstly to a very small and therefore advantageous common-mode component in the output signal, but secondly to relatively high switching losses. By contrast, discontinuous reference signals, such as the so-called flat-topped reference signal RF2 depicted in the middle part of FIG. 3, can lead to relatively low switching losses, but relatively heavy common-mode signals. By contrast, the reference signal RF3 is a reference signal optimized for the purposes of the invention that permits good common-mode rejection to be combined with low switching losses.

To generate a performance-optimizing reference signal such as this, the present invention aims to generate, under respective prevailing operating conditions, a first adjustment dataset SD1 that adjusts the reference generator RGEN such that a performance of the converter CON is optimized. The operating conditions in this case are quantified by the operating datasets BD. In this application, an optimization will also be understood to mean an approach toward an optimum.

Besides the first performance-optimizing adjustment dataset SD1, the present exemplary embodiment also comprises ascertaining a second adjustment dataset SD2 and a third adjustment dataset S3 that adjusts the pulse width modulator PWM in a performance-optimizing manner on the basis of the current operating conditions. Preferably, the second adjustment dataset SD2 adjusts a carrier frequency and/or a modulation depth of the pulse width modulation performed by the pulse width modulator PWM. In addition, the third adjustment dataset SD3 adjusts a respective changeover time of the square-wave signal RS.

The optimizable performance can relate to different target variables of the converter or of converter operation, e.g. an efficiency of the converter, a variance of the output signal VABC from the reference signal RF, a harmonic content of the output signal VABC, a stability of the output signal VABC, a common-mode component of the output signal VABC, electromagnetic interference coming from the converter CON, a maximum power of the converter CON, a temperature of components of the converter CON, a wear, a service life and/or other optimizable target variables of the converter CON.

To evaluate the performance of the converter CON, the converter controller CTL-as FIG. 1 also illustrates-has a performance evaluator EVP that ascertains a current performance of the converter CON on the basis of the acquired operating datasets BD. In the present exemplary embodiment, there is provision for multiple performance measures that evaluate different target variables of the converter CON or of converter operation.

In particular, the performance evaluator EVP can evaluate the target variables indicated above. In this case, the performance evaluator EVP takes the operating datasets BD as a basis for evaluating an efficiency of the converter CON, a variance of the output signal VABC from the reference signal RF, a harmonic content of the output signal VABC, a stability of the output signal VABC, a common-mode component of the output signal VABC and/or electromagnetic interference coming from the converter CON. A weighting of the various performance measures, which is explained in more detail below, is then used by the performance evaluator EVP to continually ascertain a weighted performance value PV that quantifies a current overall performance of the converter CON. A computation routine for computing such a performance value PV is often also referred to as a cost function in the realm of machine learning.

Alternatively or additionally, performance values can also be ascertained through simulation. For this purpose, the performance evaluator EVP can have a simulator SIM. The simulator SIM can be used to model and simulate the converter CON and the operating behavior thereof under different operating conditions. In particular, a behavior of the reference generator RGEN, a behavior of the pulse width modulator PWM and/or a behavior of the low pass filter TP can be simulated for a respective first adjustment dataset SD1, second adjustment dataset SD2 and third adjustment dataset SD3 in order to ascertain a performance value PV in this manner.

Generation of advantageous first adjustment datasets SD1, second adjustment datasets SD2 and third adjustment datasets SD3 is accomplished by training two intercoupled machine learning modules ML1 and ML2 of the converter controller CTL, by means of one or more methods of machine learning, in particular of reinforcement learning, to take supplied operating datasets BD as a basis for outputting first, second and third adjustment datasets that optimize the performance of the converter CON as above.

A training will be understood in this context to mean, in general, an optimization of a mapping of input data to output data of a machine learning module, here ML1 and ML2. This mapping is optimized according to predefined criteria during a training phase. The criteria used may be e.g. a prediction error in the case of prediction models, a classification error in the case of classification models or a performance of a technical system controlled by the output data in the case of reinforcement learning models. The training can adjust or optimize in particular network structures of neurons of a neural network, weights of connections between the neurons and/or other parameters of the mapping such that the predefined criteria are met as well as possible. The training can therefore be regarded as an optimization problem. There are a multiplicity of efficient optimization methods available for such optimization problems of machine learning. In particular, gradient descent methods, back-propagation methods, particle swarm optimizations and/or genetic optimization methods can be used.

In the present exemplary embodiment, training of the machine learning modules M1 and ML2 is accomplished—as indicated by a dashed arrow in FIG. 1—by feeding back the performance values PV ascertained by the performance evaluator EVP to the machine learning modules ML1 and ML2 in order to adjust the learning parameters thereof such that the performance values PV are ultimately optimized. In the present case, the learning parameters are adjusted such that the combined machine learning modules ML1 and ML2 output first adjustment datasets SD1, second adjustment datasets SD2 and third adjustment datasets SD3, which adjust the reference generator RGEN and the pulse width modulator PWM in a performance-optimizing manner. A specific sequence of the training is explained in more detail below.

After the training, operating datasets BD currently acquired by the sensor system S are supplied to the trained machine learning modules ML1 and ML2 during normal operation of the converter CON. The sensor system S measures in particular operating states or operating conditions of the pulse width modulator PWM and the low pass filter TP, as these generally have a significant influence on the performance of the converter CON. The measured or otherwise acquired operating states or operating conditions are quantified by the operating datasets BD.

A currently acquired operating dataset BD is used by the machine learning modules ML1 and ML2 to derive a first adjustment dataset SD1, a second adjustment dataset SD2 and a third adjustment dataset SD3. The first adjustment dataset SD1 is transmitted from the machine learning module ML1 to the reference generator RGEN in order to adjust the latter. Accordingly, the second adjustment dataset SD2 is transmitted from the machine learning module ML1 to the pulse width modulator PWM in order to adjust in particular the carrier frequency and/or modulation depth thereof. Analogously, the third adjustment dataset SD3 is transmitted from the machine learning module ML1 to the pulse width modulator PWM in order to adjust in particular the changeover times of the square-wave signal RS. On the basis of the training, according to the invention, of the machine learning modules ML1 and ML2, the reference generator RGEN and the pulse width modulator PWM are adjusted by the adjustment datasets SD1, SD2 and SD3 such that the performance of the converter CON, as weighted by the various performance measures, is optimized.

FIG. 4 illustrates a converter controller CTL according to the invention during the training of the machine learning module ML1 in a schematic representation. The converter controller CTL has one or more processors PROC for performing the method steps of the invention and one or more memories MEM for storing data to be processed.

Training of the machine learning module ML1 is accomplished by supplying a multiplicity of operating datasets BD to the converter controller CTL from the sensor system S, from a database (not shown) containing operating data of the converter CON and/or from a simulation of the converter CON. The operating datasets BD are fed into the machine learning module ML1 and into the performance evaluator EVP as input data. Stored operating datasets BD, or operating datasets BD ascertained through simulation, can be taken as a basis for performing the training of the machine learning module ML1 in particular offline, i.e. outside of normal operation of the converter CON.

Furthermore, a weight generator WGEN generates a multiplicity of different weightings of the various performance measures and feeds them in the form of weight value sets WS into the machine learning module ML1 and into the performance evaluator EVP as input data.

From the operating datasets BD supplied, the performance evaluator EVP ascertains the various performance measures. Furthermore, the performance evaluator EVP weights the ascertained performance measures with the weights specified by a respective weight value set WS in order thereby to derive a respective weighted performance value PV.

The weighting-specific performance values PV are taken as a basis for training the machine learning module ML1, preferably by means of a method of reinforcement learning, to convert a respective pair formed by an operating dataset BD and a weight value set WS into adjustment datasets SD1, SD2 and SD3, application of which optimizes, at least on average, a performance value PV weighted according to this weight value set WS.

For this purpose, a respective first output dataset SD1 of the machine learning module ML1 is fed into the reference generator RGEN and into the performance evaluator EVP in the present exemplary embodiment. The reference generator RGEN is adjusted by the first output dataset SD1 as described above. Furthermore, a respective second output dataset SD2 and a respective third output dataset SD3 of the machine learning module ML1 is fed into the pulse width modulator PWM and into the performance evaluator EVP. The pulse width modulator PWM is accordingly adjusted by the second output dataset SD2 and the third output dataset SD3 as described above.

During operation of the converter CON adjusted in this way, the sensor system S continually measures resulting operating states and operating conditions of the converter CON and transmits them to the performance evaluator EVP in the form of operating datasets BD. These operating datasets BD are taken by the performance evaluator EVP as a basis for ascertaining, as mentioned above, a respective performance value PV weighted according to a respective weight dataset WS. Alternatively or additionally, resulting operating states or operating conditions can also be ascertained through simulation. In particular, the performance evaluator EVP can use a simulator SIM to ascertain the performance measures or a respective performance value PV on the basis of current and/or earlier adjustment datasets SD1, SD2 and SD3.

The respective ascertained performance value PV is fed back, as indicated by a dashed arrow in FIG. 4, to the machine learning module ML1. The performance values PV fed back are taken as a basis for adjusting learning parameters of the machine learning module ML1 such that the performance values PV are maximized, at least on average. There are a multiplicity of efficient numerical methods available for performing such an optimization. Genetic optimization methods, deep symbolic regression methods or particle swarm optimizations are found to be particularly advantageous. In particular, so-called white box learning methods can be used, which are suitable for optimizing mathematical expressions, circuits or signal logic combinations.

The training described above renders the machine learning module ML1 able to output optimized adjustment datasets SD1, SD2 and SD3 for a respective operating dataset BD for each of many different weightings of performance measures. Although such a training often requires much more training data than a training for a standard performance measure, the machine learning module ML1, once trained, can generally still be executed very quickly. In addition, the performance measures to be applied can be provided with alternating weights or easily changed in the course of operation.

In the present exemplary embodiment, the opportunity to differently weight the performance measures is used to perform a further advantageous optimization. For this purpose, the machine learning module ML2 is supposed to be trained to take operating datasets of the converter CON as a basis for outputting a weight value set that, when fed into the trained machine learning module ML1, optimizes a performance of the converter CON.

FIG. 5 shows the converter controller CTL according to the invention during the training of the second machine learning module ML2 in a schematic representation.

Training of the machine learning module ML2 is accomplished by supplying a multiplicity of operating datasets BD to the converter controller CTL from the sensor system S, from a database (not shown) containing operating data of the converter CON and/or from a simulation of the converter CON. The operating datasets BD are fed into the trained machine learning module ML1, into the machine learning module ML2 that is to be trained and into the performance evaluator EVP as respective input data.

As already mentioned above, the machine learning module ML2 is supposed to be trained to output a performance-optimizing weight value set WS for a respective operating dataset BD. For this purpose, the output data of the machine learning module ML2 that are derived from a respective operating dataset BD are fed into the trained machine learning module ML1 as a weight value set WS together with the respective operating dataset BD. The adjustment datasets SD1, SD2 and SD3 derived from the respective operating dataset BD and the respective weight value set WS by the trained machine learning module ML1 are then used to adjust the reference generator RGEN and the pulse width modulator PWM as described above. In addition, the adjustment datasets SD1, SD2 and SD3 are also fed into the performance evaluator EVP.

During operation of the converter CON adjusted in this way, the sensor system S continually measures resulting operating states and operating conditions of the converter CON and transmits them to the performance evaluator EVP in the form of operating datasets BD. These operating datasets BD are taken by the performance evaluator EVP as a basis for ascertaining a respective performance value PV. This performance value PV can be ascertained using a firmly predefined weighting of the above performance measures or by evaluating an additionally predefined performance measure. As already mentioned above, resulting operating states and operating conditions can also be ascertained by means of the simulator SIM through simulation.

The respective ascertained performance value PV is—as indicated by a dashed arrow in FIG. 5—fed back to the machine learning module ML2. The performance values PV fed back are taken as a basis for adjusting learning parameters of the machine learning module ML2 such that the performance values PV are maximized, at least on average. There are a multiplicity of efficient numerical methods available for performing such an optimization. Gradient-based optimization methods, back-propagation methods, genetic optimization methods, deep symbolic regression methods or particle swarm optimizations are found to be particularly advantageous in this case. In particular, besides white box learning methods, so-called black box learning methods can also be used. The latter can be implemented by means of artificial neural networks, for example.

The training described above trains the machine learning module ML2 to take a respective operating dataset BD and output a respective weight value set WS that weights the performance measures in a manner optimized for the current operating state. It is found to be advantageous to perform the training of the machine learning module ML2 over a longer time horizon than a training of the machine learning module ML1.

Alternatively or additionally, the machine learning module ML2 can also be trained to take a respective operating dataset BD and select a performance measure that is advantageous for the current operating state. The trained machine learning module ML1 can then be caused to change over to the selected performance measure or to a control variant optimized therefor.

The interaction of the machine learning modules ML1 and ML2 allows different performance targets to be dynamically prioritized depending on the prevailing operating situation. As such, the optimization can automatically be based on different or differently weighted performance measures in critical operating states than during normal operation.

Insofar as electrical converters are usually designed with fixed performance targets in view of the worst case, dynamic adaptation of the performance targets often allows less complex hardware to be used. In tis way, the invention can be used to increase the efficiency of converters in many cases and at the same time to reduce hardware complexity.

1. A computer-implemented method for controlling an electrical converter (CON), wherein
a) a reference signal (RF) for an output signal (VABC) of the converter (CON) is generated by an adjustable reference generator (RGEN),
b) a square-wave signal (RS) pulse-width-modulated by the reference signal (RF) is generated by a pulse width modulator (PWM), and
c) the square-wave signal (RS) is converted into the output signal (VABC), characterized in that
d) operating datasets (BD) that specify operating conditions of the converter are continually acquired,
e) the operating datasets (BD) are continually fed into a first machine learning module (ML1), which is trained to take a respective operating dataset (BD) as a basis for outputting a respective first adjustment dataset (SD1) for adjusting the reference generator (RGEN), application of which optimizes a performance of the converter (CON), and
f) the reference generator (RGEN) is continually adjusted by first adjustment datasets (SD1) that are output by the first machine learning module (ML1).

2. The method as claimed in claim 1, characterized
in that the first machine learning module (ML1) is trained to take a respective operating dataset (BD) as a basis for outputting a respective second adjustment dataset (SD2), which specifies a carrier frequency and/or a modulation depth, for adjusting the pulse width modulator (PWM),
application of which optimizes a performance of the converter (CON), and
in that the pulse width modulator (PWM) is continually adjusted by second adjustment datasets (SD2) that are output by the first machine learning module (ML1).

3. The method as claimed in either of the preceding claims, characterized
in that the performance is specified by multiple performance measures, weighted on the basis of a weight value set (WS), for different optimizable target variables of the converter (CON),
in that the first machine learning module (ML1) is trained to take a respective operating dataset (BD) and a respective weight value set (WS) as a basis for outputting a respective first adjustment dataset (SD1) for adjusting the reference generator (RGEN), application of which optimizes the performance of the converter (CON) weighted by the respective weight value set (WS),
in that a second machine learning module (ML2) is trained to take operating datasets (BD) of the converter (CON) as a basis for selecting one of the performance measures and/or for outputting a weight value set (WS), which performance measure or weight value set, when fed into the trained first machine learning module (ML1), optimizes a performance of the converter (CON),
in that operating data (BD) of the converter (CON) are fed into the second machine learning module (ML2),
in that output data (WS) of the second machine learning module (ML2) are fed into the first machine learning module (ML1), and
in that the reference generator (RGEN) is continually adjusted by first adjustment datasets (SD1) that are output by the first machine learning module (ML1).

4. A computer-implemented method for configuring an electrical converter (CON) that has an adjustable reference generator (RGEN) for generating a reference signal (RF) for an output signal (VABC) of the converter (CON), a pulse width modulator (PWM) for generating a square-wave signal (RS) pulse-width-modulated by the reference signal (RF), and a conversion unit (TP) for converting the square-wave signal (RS) into the output signal (VABC), wherein
a) operating datasets (BD) that specify a multiplicity of operating conditions of the converter (CON) are read in,
b) each of the operating datasets (BD) is fed into a first machine learning module (ML1) as an input dataset,
c) for a particular resulting output dataset (SD1) of the first machine learning module (ML1), a performance of the converter (CON) that results from an adjustment of the reference generator (RGEN) on the basis of this output dataset (SD1) is ascertained in the form of one or more performance values (PV),
d) the first machine learning module (ML1) is trained by means of a numerical optimization method to optimize the ascertained performance values (PV), and
e) the converter (CON) is configured by the trained first machine learning module (ML1).

5. The method as claimed in claim 4, characterized in that a respective performance value (PV) is ascertained by
adjusting a simulated reference generator of a simulation model (SIM) of the converter (CON), the reference generator (RGEN) of the converter (CON) and/or a reference generator of a similar converter on the basis of the respective output dataset (SD1), and
taking this as a basis for ascertaining a performance that results during operation under the operating conditions specified by the respective operating dataset (BD).

6. The method as claimed in claim 4 or 5, characterized in that the ascertainment of the performance involves multiple performance measures for different optimizable target variables of the converter (CON) being ascertained,
in that a multiplicity of different weightings for the performance measures are generated in the form of a respective weight value set (WS), and
in that training of the first machine learning module (ML1) is accomplished by feeding the generated weight value sets (WS) together with the operating datasets (BD) into the first machine learning module (ML1) as input datasets.

7. The method as claimed in claim 6, characterized in that the trained first machine learning module (ML1) is used to train a second machine learning module (ML2) to take operating datasets (BD) of the converter (CON) as a basis for selecting one of the performance measures and/or for outputting a weight value set (WS), which performance measure or weight value set, when fed into the trained first machine learning module (ML1), optimizes a performance of the converter (CON).

8. The method as claimed in one of claims 4 to 7, characterized
in that the numerical optimization method comprises a genetic optimization method, a particle swarm optimization, a symbolic regression method and/or a back-propagation method.

9. The method as claimed in one of the preceding claims, characterized
in that a performance relates to
an efficiency of the converter (CON),
a variance of the output signal (VABC) from the reference signal (RF),
a harmonic content of the output signal (VABC),
a stability of the output signal (VABC),
a common-mode component of the output signal (VABC) and/or
electromagnetic interference coming from the converter (CON).

10. The method as claimed in one of the preceding claims, characterized
in that depending on the adjustment of the reference generator (RGEN)
the reference signal (RF) is selected from multiple provided reference signals,
a response or a shape of the reference signal (RF) is modified,
a generation process for the reference signal (RF) is modified, and/or
operators for signal logic combination and/or signal conversion are selected, which are taken as a basis for forming the reference signal (RF) from provided signals.

11. The method as claimed in one of the preceding claims, characterized
in that a respective machine learning module (ML1, ML2) comprises an artificial neural network, a Bayesian neural network, a recurrent neural network, a convolutional neural network, a multilayer perceptron, an autoencoder, a deep learning architecture, a support vector machine, a data-driven trainable regression model, a k-nearest neighbor classifier, a physical model and/or a decision tree.

12. The method as claimed in one of the preceding claims, characterized
in that the first machine learning module (ML1) used is a stateful machine learning module.

13. The method as claimed in one of claims 1 to 3, characterized
in that the first machine learning module (ML1) is trained to take a respective operating dataset (BD) as a basis for outputting a respective third adjustment dataset (SD3), which specifies a changeover time of the square-wave signal (RS), for adjusting the pulse width modulator (PWM),
application of which optimizes a performance of the converter (CON), and
in that the pulse width modulator (PWM) is continually adjusted by third adjustment datasets (SD3) that are output by the first machine learning module (ML1).

14. A converter controller (CTL) for controlling an electrical converter (CON), designed to carry out a method as claimed in one of the preceding claims.

15. An electrical converter (CON) having a converter controller (CTL) as claimed in claim 14.

16. A computer program product designed to carry out a method as claimed in one of claims 1 to 13.

17. A computer-readable storage medium having a computer program product as claimed in claim 16.
